(19) United States
(12) Patent Application Publication
(10) Pub. No.: US 2025/0351110 A1
(43) Pub. Date: Nov. 13, 2025

(54) POSITION DETERMINATION OF A USER EQUIPMENT

(71) Applicant: Telefonaktiebolaget LM Ericsson (publ), Stockholm (SE)

(72) Inventors: Behrooz MAKKI, Pixbo (SE); Magnus ÅSTRÖM, Lund (SE); Andreas NILSSON, Göteborg (SE)

(73) Assignee: Telefonaktiebolaget LM Ericsson (publ), Stockholm (SE)

(21) Appl. No.: 18/860,350

(22) PCT Filed: Apr. 29, 2022
(86) PCT No.: PCT/EP2022/061571

§ 371 Date: Oct. 25, 2024

(51) Int. Cl. H04W 64/00; H04L 5/00; H04W 16/28; H04W 24/10

(52) U.S. Cl. CPC H04W 64/00; H04L 5/0051; H04W 16/28; H04W 24/10

(57) ABSTRACT

There is provided techniques for position determination of a user equipment. A method is performed by a network node. The network node serves the user equipment in a radio environment over at least one indirect path via a respective reflector node and over a direct path. The location of the reflector node relative the location of the network node is known by the network node. The method comprises obtaining measurements relative the user equipment. The measurements pertain to properties of the indirect path and the direct path. The measurements are based on signals communicated between the network node and the user equipment via the indirect path and via the direct path. The method comprises determining the position of the user equipment using triangulation based on the measurements.

### TECHNICAL FIELD

Embodiments presented herein relate to methods, a network node, a user equipment, computer programs, and a computer program product for position determination of the user equipment.

### BACKGROUND

Millimeter waves (mmWaves) corresponding to carrier frequencies above 10 GHz have been introduced for the new radio (NR) air interface as used in fifth generation (5G) telecommunication systems. Capacity of such systems could be increased by the deployment of small nodes, of various types to assist existing macro access nodes, or network nodes. In this respect, FIG. 1 shows an example of a communication network 100. The communication network 100 comprises a network node 200 (for example provided as a (radio) access network node) that is configured to provide network access to user equipment, one of which is shown at reference numeral 140. As illustrated in the figure, there is a direct path 120 as well as an indirect path 130a, 130b between the network node 200 and the user equipment 300. Communication between the network node 200 and the user equipment 300 along the indirect path 130a, 130b is relayed via a small node being a reflector node 110. The indirect path 130a, 130b thus has a first part 130a (between the network node 200 and the reflector node 110) and a second part (between the reflector node 110 and the user equipment 300).

In this respect, the reflector node 110 constitutes part of a smart radio environment. In this respect, one technique enabling the creation of smart radio environments involves the use of surfaces that can interact with the radio environment. As disclosed in, for example, “Smart Radio Environments Empowered by Al Reconfigurable Meta-Surfaces: An Idea Whose Time Has Come” by Marco Di Renzo et al., as accessible on https://arxiv.org/abs/1903.08925 (latest accessed 11 Apr. 2022), “Reconfigurable-Intelligent-Surface Empowered Wireless Communications: Challenges and Opportunities” by Xiaojun Yuan et al., as accessible on https://arxiv.org/abs/2001.00364 (latest accessed 11 Apr. 2022), and “Intelligent Reflecting Surface Enhanced Wireless Network via Joint Active and Passive Beamforming” by Q. Wu and R. Zhang, in IEEE Transactions on Wireless Communications, vol. 18, no. 11, pp. 5394-5409 November 2019, doi: 10.1109/TWC.2019.2936025 such surfaces are commonly called meta-surfaces, reconfigurable intelligent surfaces, large intelligent surfaces, intelligent reconfigurable surfaces, or repeater modules and represent an emerging technology that is capable of intelligently manipulating the propagation of electro-magnetic waves. Without loss of generality or discrimination between these terms, the term repeater module will be used throughout this disclosure.

FIG. 2 is a schematic illustration of a reflector node 110. The reflector node 110 comprises a controller module 112 and a repeater module 118, comprising a meta-surface or other type of array structure with patch antennas. In turn, the controller module 112 comprises, or houses, a controller 114 for controlling the reflection angle of the repeater module 118 for reflecting radio waves over an indirect path 130a, 130b between the network node 200 and the user equipment 300. The controller module 112 further comprises, or houses, a transceiver unit 116 for receiving instructions from the network node 200 over a control channel 120 regarding how the reflection angle of the repeater module 118 is to be controlled. In further detail, by the controller 114 controlling the impedances of the respective patch antennas, the reflection angle of an incoming radio wave can be adapted according to the generalized Snell's law. In some examples, the reflector node 110 is a network-controlled repeater. As the skilled person understand, FIG. 2 only illustrates one example implementation of the reflector node 110 and the implementation might differ dependent on the type of reflector node 110. For example, a network-controlled repeater might have a different implementation, but the general concept is the same, namely that the network-controlled repeater will cause an impinging beam to be reflected in a controllable direction.

Thus, with reference back to the example of FIG. 1, if the reflector node 110 is provided with a passive repeater module and a controller module, the reflection of a signal transmitted by the network node 200 could be controlled such that the signal reaches the user equipment 300 not only via a line-of-sight signal path corresponding to the direct path 120 but also via a non-line-of-sight signal paths corresponding to the indirect path 130a, 130b.

However, although the use of one or more reflector nodes 110 may improve the throughput of signals communicated between the network node and the user equipment and hence increase the network performance, for such improvements to occur, the position of the user equipment 300 relative the network node 200 should be known. However, conventional techniques for determining the position of user equipment 300 are not suitable for communication networks in which reflector nodes 110 are deployed.

### SUMMARY

An object of embodiments herein is to address the above issues. In some aspects, the above issues are addressed by providing techniques that are accurate, computationally efficient, and resource efficient (in terms of overhead signalling etc.) for position determination of user equipment in communication networks in which one or more reflector nodes are deployed.

According to a first aspect there is presented a method for position determination of a user equipment. The method is performed by a network node. The network node serves the user equipment in a radio environment over at least one indirect path via a respective reflector node and over a direct path. The location of the reflector node relative the location of the network node is known by the network node. The method comprises obtaining measurements relative the user equipment. The measurements pertain to properties of the indirect path and the direct path. The measurements are based on signals communicated between the network node and the user equipment via the indirect path and via the direct path. The method comprises determining the position of the user equipment using triangulation based on the measurements.

According to a second aspect there is presented a network node for position determination of a user equipment. The network node is configured to serve the user equipment in a radio environment over at least one indirect path via a respective reflector node and over a direct path. The location of the reflector node relative the location of the network node is known by the network node. The network node comprises processing circuitry. The processing circuitry is configured to cause the network node to obtain measurements relative the user equipment. The measurements pertain to properties of the indirect path and the direct path. The measurements are based on signals communicated between the network node and the user equipment via the indirect path and via the direct path. The processing circuitry is configured to cause the network node to determine the position of the user equipment using triangulation based on the measurements.

According to a third aspect there is presented a network node for position determination of a user equipment. The network node is configured to serve the user equipment in a radio environment over at least one indirect path via a respective reflector node and over a direct path. The location of the reflector node relative the location of the network node is known by the network node. The network node comprises an obtain module configured to obtain measurements relative the user equipment. The measurements pertain to properties of the indirect path and the direct path. The measurements are based on signals communicated between the network node and the user equipment via the indirect path and via the direct path. The network node comprises a determine module configured to determine the position of the user equipment using triangulation based on the measurements.

According to a fourth aspect there is presented a computer program for position determination of a user equipment, the computer program comprising computer program code which, when run on processing circuitry of a network node, causes the network node to perform a method according to the first aspect.

According to a fifth aspect there is presented a method for position determination. The method is performed by a user equipment. The user equipment is served by a network node in a radio environment over at least one indirect path via a respective reflector node and over a direct path. The location of the reflector node relative the location of the network node is known by the user equipment. The method comprises obtaining measurements relative the network node. The measurements pertain to properties of the indirect path and the direct path. The measurements are based on signals communicated between the user equipment and the network node via the indirect path and via the direct path. The method comprises determining the position of the user equipment using triangulation based on the measurements.

According to a sixth aspect there is presented a user equipment for position determination. The user equipment is configured to be served by a network node in a radio environment over at least one indirect path via a respective reflector node and over a direct path. The location of the reflector node relative the location of the network node is known by the user equipment. The user equipment comprises processing circuitry. The processing circuitry is configured to cause the user equipment to obtain measurements relative the network node. The measurements pertain to properties of the indirect path and the direct path. The measurements are based on signals communicated between the user equipment and the network node via the indirect path and via the direct path. The processing circuitry is configured to cause the user equipment to determine the position of the user equipment using triangulation based on the measurements.

According to a seventh aspect there is presented a user equipment for position determination. The user equipment is configured to be served by a network node in a radio environment over at least one indirect path via a respective reflector node and over a direct path. The location of the reflector node relative the location of the network node is known by the user equipment. The user equipment comprises an obtain module configured to obtain measurements relative the network node. The measurements pertain to properties of the indirect path and the direct path. The measurements are based on signals communicated between the user equipment and the network node via the indirect path and via the direct path. The user equipment comprises a determine module configured to determine the position of the user equipment using triangulation based on the measurements.

According to an eighth aspect there is presented a computer program for position determination, the computer program comprising computer program code which, when run on processing circuitry of a user equipment, causes the user equipment to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects enable accurate, computationally efficient, and resource efficient (in terms of overhead signalling etc.) position determination of user equipment in communication networks in which one or more reflector nodes are deployed.

Advantageously, these aspects enable accurate positioning determination of user equipment with the aid of one or more reflector node.

Advantageously, the accurate positioning determination of the user equipment improves the network performance. For example, by knowing the position of the user equipment, the network node can perform more precisely directed beamformed transmission towards the user equipment.

Advantageously, these aspects enable determination of whether the network node has a line-of-sight connection to the user equipment or not. In turn, this information can be used to estimate the reliability of the positioning determination of the user equipment.

Advantageously, these aspects are applicable for measurements made both in the uplink and in the downlink.

Advantageously, these aspects enable the same principles to be applied for the position of the user equipment to be determined either by the network node or by the user equipment itself.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1, 4, and 5 are schematic diagrams illustrating a communication network according to embodiments;

FIG. 2 is a schematic illustration of a reflector node according to an embodiment;

FIGS. 3, 6, 7, 8, and 9 are flowcharts of methods according to embodiments;

FIG. 10 is a schematic diagram showing functional units of a network node according to an embodiment;

FIG. 11 is a schematic diagram showing functional modules of a network node according to an embodiment;

FIG. 12 is a schematic diagram showing functional units of a user equipment according to an embodiment;

FIG. 13 is a schematic diagram showing functional modules of a user equipment according to an embodiment; and

FIG. 14 shows one example of a computer program product comprising computer readable means according to an embodiment.

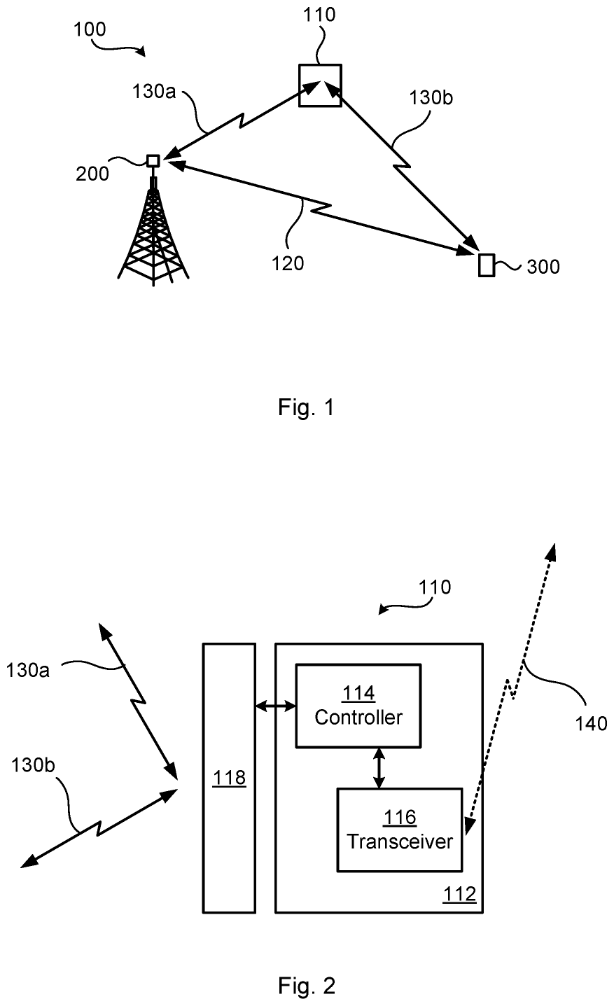

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, there is still a need for position determination of user equipment in communication networks in which one or more reflector nodes are deployed.

One particular object of the herein disclosed embodiments is therefore to develop efficient techniques for determining the position of user equipment with the use of one or more reflector nodes.

The techniques should be applicable to measurements made both in the uplink and in the downlink.

The techniques should enable the position of the user equipment to be determined either by the network node or by the user equipment itself.

The embodiments disclosed herein in particular relate to techniques for position determination of a user equipment 300. In order to obtain such techniques there is provided a network node 200, a method performed by the network node 200, a computer program product comprising code, for example in the form of a computer program, that when run on processing circuitry of the network node 200, causes the network node 200 to perform the method. In order to obtain such techniques there is further provided a user equipment 300, a method performed by the user equipment 300, and a computer program product comprising code, for example in the form of a computer program, that when run on processing circuitry of the user equipment 300, causes the user equipment 300 to perform the method.

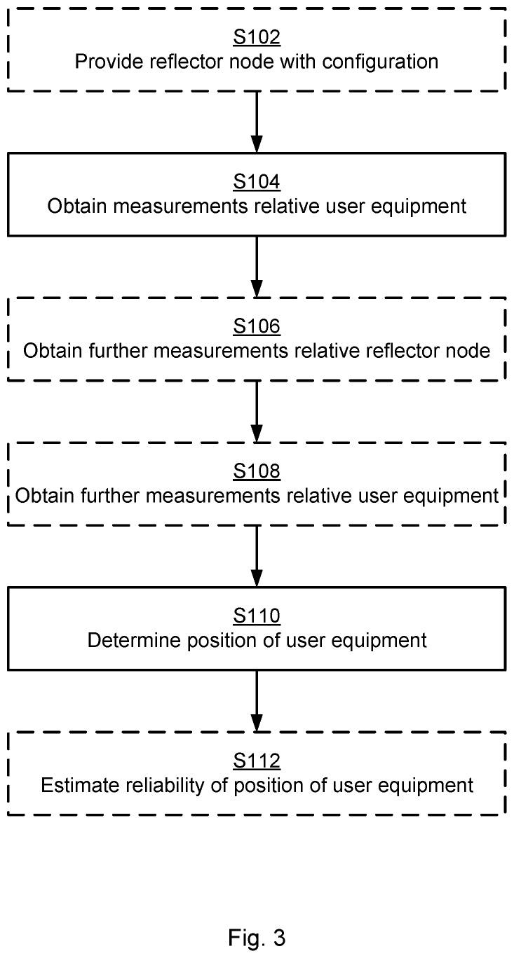

Reference is now made to FIG. 3 illustrating a method for position determination of a user equipment 300 as performed by the network node 200 according to an embodiment. The method is performed by a network node 200. The network node 200 serves the user equipment 300 in a radio environment over at least one indirect path 130a, 130b via a respective reflector node 110 and over a direct path 120. The location of the reflector node 110 relative the location of the network node 200 is known by the network node 200.
S104: The network node 200 obtains measurements relative the user equipment 300. The measurements pertain to properties of the indirect path 130a, 130b and the direct path 120. The measurements are based on signals communicated between the network node 200 and the user equipment 300 via the indirect path 130a, 130b and via the direct path 120.
S110: The network node 200 determines the position of the user equipment 300 using triangulation based on the measurements.

Embodiments relating to further details of position determination of a user equipment 300 as performed by the network node 200 will now be disclosed.

Different examples of reflector nodes 110 have been disclosed above.

In some examples, the signals communicated between the user equipment 300 and the network node 200 via the indirect path 130a, 130b and via the direct path 120 are millimeter wave signals or Terahertz signals.

Embodiments relating to the network node 200 determining the position of the user equipment 300 based on measurements on reference signals will be disclosed next. As will be further disclosed below, the reference signals might be downlink reference signals (such as any of positioning reference signals, channel state information reference signals, synchronization signal block signals, demodulation reference signals, or the like) or uplink reference signals (such as sounding reference signals, demodulation reference signals, or the like).

Aspects of how the network node 200 might configure one or more reflector nodes 110 for the one or more reflector nodes 110 to properly relay beamformed signals between the network node 200 and the user equipment 300 will be disclosed next.

In some embodiments, the network node 200 is configured to perform (optional) step S102.
S102: The network node 200 provides the reflector node 110 with configuration for the reflector node 110 to apply when acting as a relay between the network node 200 and the user equipment 300. The configuration pertains to any of: reflection angle or direction, reflection beam spread or surface convexity, time instants and/or the periodicity during which the configuration is to be applied.

The beams to be used by the reflector node 110 for the second part 130b of the indirect path can be determined, for instance, during a beam sweep procedure performed for the reflector node 110. Configurations provided by the network node 200 to the reflector node 110 might comprise the reflection angle or direction of one or more beams to be used by the reflector node 110 for the second part 130b of the indirect path, the reflection beam spread or surface convexity, the time instants and/or the periodicity during which the configuration should be applied, etc. Communication in mmW bands or Terahertz bands with narrow beams can be used to ensure that the indirect path 130a, 130b is correctly reflected by the reflector node 110 towards the user equipment 300.

Aspects of how the network node 200 might obtain properties of all available reflector nodes 110 and how the network node 200 might select a suitable subset of reflector nodes 110 based on the obtained properties will be disclosed next.

Non-limiting examples of such properties are: information about the position of the one or more reflector nodes 110, the preferred beam(s) to be used by the network node 200 and the reflector node 110 for the first part 130a of the indirect path, propagation delay for the link on the first part 130a of the indirect path, latency caused by time delay, or other type of processing delay, during signal amplification and forwarding at the reflector node 110, etc.

There are different ways to obtain the information about the reflector node 110 position and the propagation delay. In some examples, the network node 200 might determine the position of each reflector node 110 either by accessing computer-readable documentation or by receiving such information from another network node 200 or from the reflector nodes 110 themselves. Alternatively, the network node 200 might determine the position of the reflector node 110 by configuring the reflector node 110 to reflect a signal received in a beam from the network node 200 back in the same direction as the signal was received. This enables the network node 200 to accordingly determine the propagation delay and/or the position of the reflector node 110.

The network node 200 might then select one or more reflector node 110 for which the properties fulfil some criteria. The criteria could pertain to the position of the reflector node 110 being within a certain geographical area, the propagation delay being below some upper threshold limit, the reflector node 110 having some required beamforming capabilities, maximum latency, etc.

Once the positions of the reflector node 110 and the network node 200 are known, it is straightforward to determine the propagation delay for the link on the first part 130a of the indirect path.

Aspects of how the network node 200 might obtain measurements relative the user equipment 300 on the indirect link via the reflector node 110 will be disclosed next.

In some aspects, once the appropriate beams for the link on the first part 130a and the second part 130b of the indirect path have been determined, either the network node 200 transmits at least one downlink reference signal towards the at least one reflector node 110 and, using the configurations determined as above, the reflector node 110 reflects the signal towards the user equipment 300, or the user equipment 300 transmits at least one uplink reference signal towards the at least one reflector node 110 and, using the configurations determined as above, the reflector node 110 reflects the signal towards the network node 200. In some embodiments, the signals are downlink reference signals sent by the network node 200 towards the user equipment 300 over the indirect path 130a, 130b. The measurements are made by the user equipment 300 on the downlink reference signals and reported to the network node 200. In some embodiments, the signals are uplink reference signals sent by the user equipment 300 and received by the network node 200 over the indirect path 130a, 130b. The measurements are made by the network node 200 on the uplink reference signals. The network node 200 then determines the position of the user equipment 300 using triangulation based on measurements pertaining to timing information of the indirect path 130a, 130b and the direct path 120.

Aspects of how the network node 200 might obtain measurements relative the user equipment 300 on the direct link will be disclosed next.

In some aspects, the network node 200 determines which beam towards the user equipment 300 to use for communication with the user equipment 300 over the direct path 120. Then, adjacent, i.e., before or after, to having communicated reference signals via the reflector node 110, the network node 200 and the user equipment 300 communicate reference signals over the direct path 120. As above, the reference signals might either be downlink reference signals (and hence transmitted by the network node 200) or uplink reference signals (and hence be transmitted by the user equipment 300). In some embodiments, the signals are downlink reference signals sent by the network node 200 towards the user equipment 300 over the direct path 120. The measurements are made by the user equipment 300 on the downlink reference signals and reported to the network node 200. In some embodiments, the signals are uplink reference signals sent by the user equipment 300 and received by the network node 200 over the direct path 120. The measurements are made by the network node 200 on the uplink reference signals. The network node 200 then determines the position of the user equipment 300 using triangulation based on measurements pertaining to timing information of the indirect path 130a, 130b and the direct path 120.

In this way, different reference signals over both the direct path 120 and at least one indirect path 130a, 130b (depending on how many reflector nodes 110 are involved), are communicated between the network node 200 and the user equipment 300. As will be further disclosed below, measurements based on the reference signals yield timing information that can be used to determine the position of the user equipment 300.

Aspects of how the network node 200 might determine the position of the user equipment 300 based on obtained measurements reflecting timing information will be disclosed next.

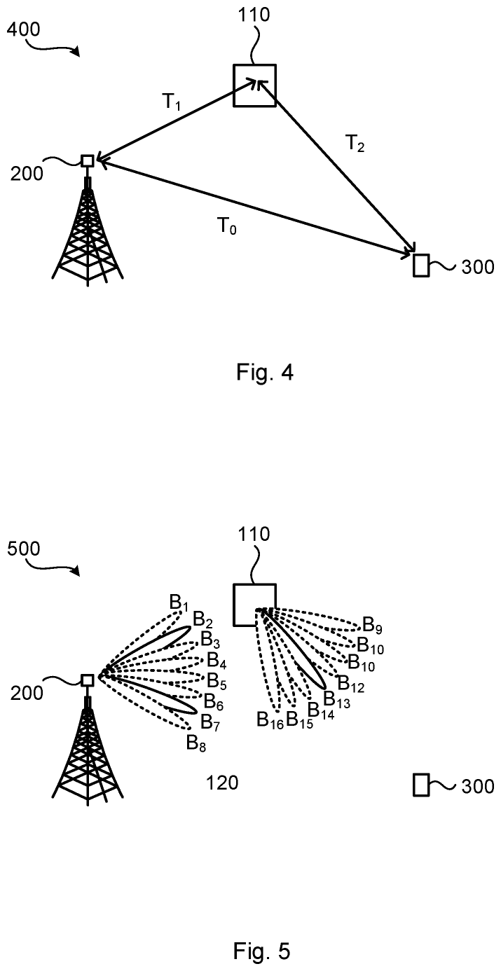

Parallel reference is here made to FIG. 4. FIG. 4 shows an example of a communication network 400 with the same components as the communication network 100. The communication network 400 thus comprises a network node 200 configured to provide network access to user equipment 300 and a reflector node 110. There is a direct path as well as an indirect path between the network node 200 and the user equipment 300. In FIG. 4, is indicated the propagation delays T₀, T₁, T₂ for each path. In some aspects, once the network node 200 has obtained the measurements (either in reports from the user equipment 300 if the reference signals were downlink reference signals, or by conducting its own measurements if the reference signals were uplink reference signals) with timing information for different reference signals, for instance the values of T₀ and T₁+T₂ in FIG. 4, the network node 200 can determine the position of the user equipment 300 using triangulation. Hence, in some embodiments, the position of the user equipment 300 is determined based on propagation delays T₀, T₁, T₂ for the indirect path 130a, 130b and the direct path 120 as determined based on the timing information. In some examples, the timing information is defined by time-of-arrival values.

Here, the network node 200 first uses the information about its own position and the position of the reflector nodes 110 to determine the time delay between the network node 200 and the reflector nodes 110, i.e., T₁ in FIG. 4. Then, the network node 200 determines the delay between the reflector node 110 and the user equipment 300, i.e., T₂ in FIG. 4, by using the total time delay of the reference signals communicated via the reflector node 110, i.e., T₁+T₂ in FIG. 4, and subtracting the total delay T₁+T₂ with the calculated delay between the network node 200 and the reflector nodes 110, i.e., T₁. Thus, T₂=(T₁+T₂)−T₁, where the values of both T₁+T₂ and T₁ are known. Further, the network node 200 performs triangulation based on knowing its own position and the position of the reflector node 110 in combination with the estimated time delays T₀ and T₂. It is noted that, as shown in FIG. 4, it is sufficient to have one reflector node 110 if the position of the user equipment 300 is to be determined in a plane. However, at least two reflector nodes 110 may be required for determining the position of the user equipment 300 in a three-dimensional space. Artificial Intelligence and/or Machine Learning techniques can be used to, based on prior training, improve the accuracy of the position determination of the user equipment 300, thereby accounting for spatial properties of the surroundings of the reflector node 110, etc.

In some aspects, the network node 200 uses additional timing information, for example obtained from a further network node which also has communicated reference signals (downlink reference signals or uplink reference signals) with the same user equipment 300, over a direct path and/or possible over an indirect path via the same or another reflector node 110. Hence, in some embodiments, the network node 200 is configured to perform (optional) step S108.
S108: The network node 200 obtains further measurements relative the user equipment 300 from another network node. The position of the user equipment 300 is then determined also based on these further measurements.

For example, the user equipment 300 might communicate a first set of reference signals directly with the network node 200, communicate a second set of reference signals with the network node 200 via the reflector node 110, and communicate a third set of reference signals with a further network node. In such cases the position of the user equipment 300 might be determined based on Time Difference Of Arrival (TDOA) estimates, where the user equipment 300 measures the Received Signal Time Difference (RSTD) between the first path of different received reference signals (for example the reference signals conveyed through the reflector node 110 and the reference signal from the further network node) and the first path of the received reference signals from the network node 200.

By utilizing the two estimated RSTDs, and the known positions of the different network nodes as well as the reflector nodes 110, triangulation can be performed to determine the position of the user equipment 300.

Aspects of how the network node 200 might estimate reliability of the determined position of the user equipment 300 will be disclosed next.

In some embodiments, the network node 200 is configured to perform (optional) step S112.
S112: The network node 200 estimates reliability of the position of the user equipment 300 based on the obtained measurements.

In some aspects, the reliability of the determined position of the user equipment 300 is estimated by checking the probability of the paths (both the direct path 120 and the indirect path 130a, 130b) being line-of-sight paths. In this respect, whether the first part 130a is a line-of-sight path or not might not matter if the relative positions of the network node 200 and the one or more reflector nodes 110 is known.

Particularly, the estimated position of the user equipment 300 and information of beam directions of the reflector nodes 110 and the network node 200 used for communicating with the user equipment 300 are used to estimate the probability of that a line-of-sight path was used between the user equipment 300 and each of the reflector nodes 110 and the network node 200. If line-of-sight paths are not used between the user equipment 300 and each of the reflector nodes 110 and the network node 200 during triangulation, the determined position is deemed not reliable. Otherwise the determined position is deemed reliable. This is based on the assumption that if a line-of-sight path exists between a node and a user equipment 300, a beam, as generated by the node, that points in the direction along the line-of-sight path is the strongest beam.

Embodiments relating to the network node 200 determining the position of the user equipment 300 based on beam direction information will be disclosed next.

The network node 200 might configure one or more reflector nodes 110 to properly relay beamformed signals between the network node 200 and the user equipment 300 as disclosed above.

The network node 200 might obtain properties of all available reflector nodes 110 and might select a suitable subset of reflector nodes 110 based on the obtained properties as disclosed above.

Aspects of how the network node 200 might determine the direction for beamformed communication for the second part 130b of the indirect path between the network node 200 and the user equipment 300 will now be disclosed.

In some aspects, the direction is determined by a beam sweeping procedure being performed at the reflector node 110. The beam sweeping procedure is controlled by the network node 200.

Parallel reference is here made to FIG. 5. FIG. 5 shows an example of a communication network 500 with the same components as the communication network 100. The communication network 500 thus comprises a network node 200 configured to provide network access to user equipment 300 and a reflector node 110. There is a direct path as well as an indirect path between the network node 200 and the user equipment 300. In FIG. 5 is illustrated beams B1:B8 used by the network node 200 and beams B9:B16 used by the reflector node 110.

In some embodiments, the signals are downlink signals sent in directional beams B1:B8 by the network node 200 towards the user equipment 300 over the indirect path 130a, 130b. The measurements are made by the user equipment 300 on the downlink signals and reported to the network node 200. The network node 200 then determines the position of the user equipment 300 using triangulation based on measurements pertaining to directional information of the downlink signals. In some embodiments, the signals are uplink signals sent by the user equipment 300 and received by the reflector node 110 in any of directional beams B9:B16 and then reflected towards the network node 200. The measurements are made by the network node 200. The network node 200 then determines the position of the user equipment 300 using triangulation based on measurements pertaining to directional information of the uplink signals.

Depending on which beam B1:B8 is used by the network node 200, a signal might impinge, and thus be reflected by, the reflector node 110 to be forwarded towards the user equipment 300. Depending on which beam B9:B16 is used by the reflector node 110, a signal reflected by the reflector node 110 might reach the user equipment 300. According to the illustrative example in FIG. 5, a signal transmitted in beam B2 reaches the reflector node 110, and a signal reflected in beam B13 reaches the user equipment 300.

Aspects of how the network node 200 might determine the direction for beamformed communication for the direct path 120 between the network node 200 and the user equipment 300 will now be disclosed.

In some embodiments, the signals are downlink signals sent in directional beams B1:B16 by the network node 200 towards the user equipment 300 over the direct path 120. The measurements are made by the user equipment 300 on the downlink signals and reported to the network node 200. The network node 200 then determines the position of the user equipment 300 using triangulation based on measurements pertaining to directional information of the downlink signals. In some embodiments, the signals are uplink signals sent by the user equipment 300 and received by the network node 200 in any of directional beams B1:B8. The measurements are made by the network node 200. The network node 200 then determines the position of the user equipment 300 using triangulation based on measurements pertaining to directional information of the uplink signals. Depending on which beam B1:B8 is used by the network node 200, a signal might reach the user equipment 300. According to the illustrative example in FIG. 5, a signal transmitted in beam B7 reaches the user equipment 300.

Aspects of how the network node 200 might determine the position of the reflector node 110 will be disclosed next.

As disclosed above, in some examples, the network node 200 might determine the position of the reflector node 110 by configuring the reflector node 110 to reflect a signal received in a beam from the network node 200 back in the same direction as the signal was received. This enables the network node 200 to accordingly determine the propagation delay and/or the position of the reflector node 110.

As further disclosed above, in some examples, the network node 200 might determine the position of each reflector node 110 either by accessing computer-readable documentation or by receiving such information from another network node 200 or from the reflector nodes 110 themselves.

Aspects of how the network node 200 might determine the position of the user equipment 300 based on obtained measurements reflecting directional information will be disclosed next.

In some aspects, the beam directions used for communicating with the user equipment 300 are used for triangulation. This is illustrated in FIG. 5. Hence, in some embodiments, the position of the user equipment 300 is determined based on the directional information for the indirect path 130a, 130b and the direct path 120. In some examples, the directional information is defined by received signal power in the directional beams B1:B16. In other examples, the directional information is defined by angle-of-arrival values.

The network node 200 might estimate reliability of the determined position of the user equipment 300 as disclosed above.

In general terms, depending on capabilities, implementations, and properties, of the reflector node 110, different methods and types of information may be used by the network node 200 when determining the position of the user equipment 300.

For instance, reflector nodes 110 implemented with RISs may suffer from poor beamforming capabilities whilst only producing negligible processing delay. Therefore, as the primary but not liming choice, with RISs one may consider the propagation delays of different links, along with the RISs position information, for determining the links distances and the position of the user equipment 300. Smart repeaters, or network-controlled repeaters, on the other hand, have high directional beamforming capabilities, whilst causing small processing delay.

Hence, in some embodiments, the network node 200 is configured to perform (optional) step S106.
S106: The network node 200 obtains further measurements relative the reflector node 110. These further measurements pertain to properties of the indirect path 130a between the network node 200 and the reflector node 110. The position of the user equipment 300 is then determined also based on these further measurements.

In some examples, the properties of the indirect path 130a between the network node 200 and the reflector node 110 are at least one of: propagation delay of the indirect path 130a, and relative direction of the indirect path 130a relative the network node 200.

In some examples it is assumed that the reflector node 110 has a processing delay and/or latency for reflecting the signals communicated between the network node 200 and the user equipment 300 via the reflector node 110.

The measurements relative the user equipment 300 might then be compensated for the processing delay and/or latency.

Further in this respect, the triangulation can be performed in different ways, via the combination of propagation delays, beam directions, and measurements on either uplink or downlink reference signals.

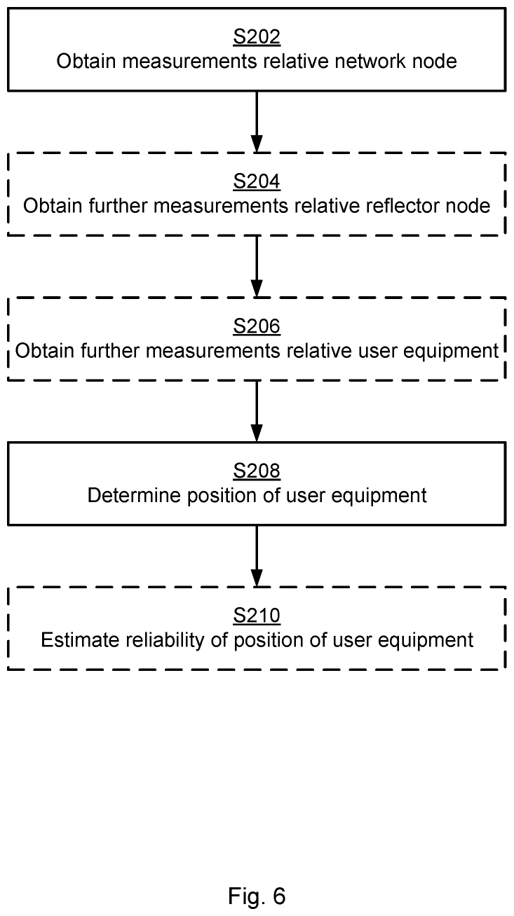

Above has been disclosed how the position of the user equipment 300 can be determined by the network node 200. However, the same principles can be well applied at the user equipment 300 itself. Reference is therefore made to FIG. 6 illustrating a method for position determination as performed by the user equipment 300 according to an embodiment. The user equipment 300 is served by a network node 200 in a radio environment over at least one indirect path 130a, 130b via a respective reflector node 110 and over a direct path 120. The location of the reflector node 110 relative the location of the network node 200 is known by the user equipment 300.
S202: The user equipment 300 obtains measurements relative the network node 200. The measurements pertain to properties of the indirect path 130a, 130b and the direct path 120. The measurements are based on signals communicated between the user equipment 300 and the network node 200 via the indirect path 130a, 130b and via the direct path 120.
S208: The user equipment 300 determines the position of the user equipment 300 using triangulation based on the measurements.

Embodiments relating to further details of position determination as performed by the user equipment 300 will now be disclosed.

In general terms, the embodiments, aspects, and examples as disclosed above with reference to the methods for position determination of the user equipment 300 as performed by the network node 200 also apply here. Some of the above-disclosed embodiments, aspects, and examples are repeated hereinafter for completeness of this disclosure.

In some examples, the signals communicated between the user equipment 300 and the network node 200 via the indirect path 130a, 130b and via the direct path 120 are millimeter wave signals or Terahertz signals.

The network node 200 might configure one or more reflector nodes 110 to properly relay beamformed signals between the network node 200 and the user equipment 300 as disclosed above. In some aspects, once the appropriate beams for the link on the first part 130a and the second part 130b of the indirect path have been determined, either the network node 200 transmits at least one downlink reference signal towards the at least one reflector node 110 and, using the configurations determined as above, the reflector node 110 reflects the signal towards the user equipment 300, or the user equipment 300 transmits at least one uplink reference signal towards the at least one reflector node 110 and, using the configurations determined as above, the reflector node 110 reflects the signal towards the network node 200.

Aspects of how the user equipment 300 might determine its position based on obtained measurements reflecting timing information will be disclosed next.

In some embodiments, the signals are downlink reference signals sent by the network node 200 towards the user equipment 300 over the indirect path 130a, 130b and the direct path 120, where the properties of the measurements obtained in S202 pertain to timing information, and where the measurements are made by the user equipment 300 on the downlink reference signals. In other embodiments, the signals are uplink reference signals sent by the user equipment 300 and received by the network node 200 over the indirect path 130a, 130b and the direct path 120, where the properties of the measurements obtained in S202 pertain to timing information, and where the measurements are made by the network node 200 on the uplink reference signals and reported to the user equipment 300.

The user equipment 300 might then determine its position relative the network node 200 using triangulation based on the propagation delay for the paths, as determined based on the timing information. Hence, in some embodiments, the position of the user equipment 300 is determined based on the propagation delays T₀, T₁, T₂ for the indirect path 130a, 130b and the direct path 120 as determined based on the timing information. In some examples, the timing information is defined by time-of-arrival values. In this respect, in some examples the value of T₁ is signalled to the user equipment 300.

Aspects of how the user equipment 300 might determine its position based on beam direction information will be disclosed next.

In some embodiments, the signals are downlink signals sent in directional beams B1:B16 by the network node 200 towards the user equipment 300 over the indirect path 130a, 130b and the direct path 120, where the properties of the measurements obtained in S202 pertain to directional information of the downlink signals, and where the measurements are made by the user equipment 300 on the downlink signals. In other embodiments, the signals are uplink signals sent by the user equipment 300 and received by the network node 200 and the reflector node 110 in directional beams B1:B16, where the properties of the measurements obtained in S202 pertain to directional information of the uplink signals, and where the measurements are made by the network node 200 and reported to the user equipment 300.

The user equipment 300 might then determine its position relative the network node 200 using triangulation based on the direction information. That is, in some embodiments, the position of the user equipment 300 is determined based on the directional information for the indirect path 130a, 130b and the direct path 120. The directional information is defined by received signal power in the directional beams B1:B16. In some examples, the directional information is defined by angle-of-arrival values.

As disclosed above, in general terms, depending on capabilities, implementations, and properties, of the reflector node 110, different methods and types of information may be used by the network node 200 when determining the position of the user equipment 300.

Hence, in some embodiments, the user equipment 300 is configured to perform (optional) step S204.
S204: The user equipment 300 obtains further measurements relative the reflector node 110. These further measurements pertain to properties of the indirect path 130a between the network node 200 and the reflector node 110. The position of the user equipment 300 is then determined also based on these further measurements.

In some examples, the properties of the indirect path 130a between the network node 200 and the reflector node 110 are at least one of propagation delay of the indirect path 130a, and relative direction of the indirect path 130a relative the network node 200.

As disclosed above, in some examples it is assumed that the reflector node 110 has a processing delay and/or latency for reflecting the signals communicated between the network node 200 and the user equipment 300 via the reflector node 110. The measurements relative the user equipment 300 might then be compensated for the processing delay and/or latency.

In some aspects, the user equipment 300 uses additional timing information, for example obtained from a further network node which also has communicated reference signals (downlink reference signals or uplink reference signals) with the user equipment 300, over a direct path and/or possible over an indirect path via the same or another reflector node 110. Hence, in some embodiments, the user equipment 300 is configured to perform (optional) step S206.
S206: The user equipment 300 obtains further measurements relative the user equipment 300 from another network node. The position of the user equipment 300 is then determined also based on these further measurements.

For example, the user equipment 300 might communicate a first set of reference signals directly with the network node 200, communicate a second set of reference signals with the network node 200 via the reflector node 110, and communicate a third set of reference signals with a further network node. In such cases the position of the user equipment 300 might be determined based on TDOA estimates, where the user equipment 300 measures the RSTD between the first path of different received reference signals (for example the reference signals conveyed through the reflector node 110 and the reference signal from the further network node) and the first path of the received reference signals from the network node 200.

The user equipment 300 might estimate reliability of its determined position. Thus, in some embodiments, the user equipment 300 is configured to perform (optional) step S210.
S210: The user equipment 300 estimates reliability of the position of the user equipment 300 based on the obtained measurements.

As above, in some aspects, the reliability of the determined position of the user equipment 300 is estimated by checking the probability of the paths (both the direct path 120 and the indirect path 130a, 130b) being line-of-sight paths. Again, whether the first part 130a is a line-of-sight path or not might not matter if the relative positions of the network node 200 and the one or more reflector nodes 110 is known.

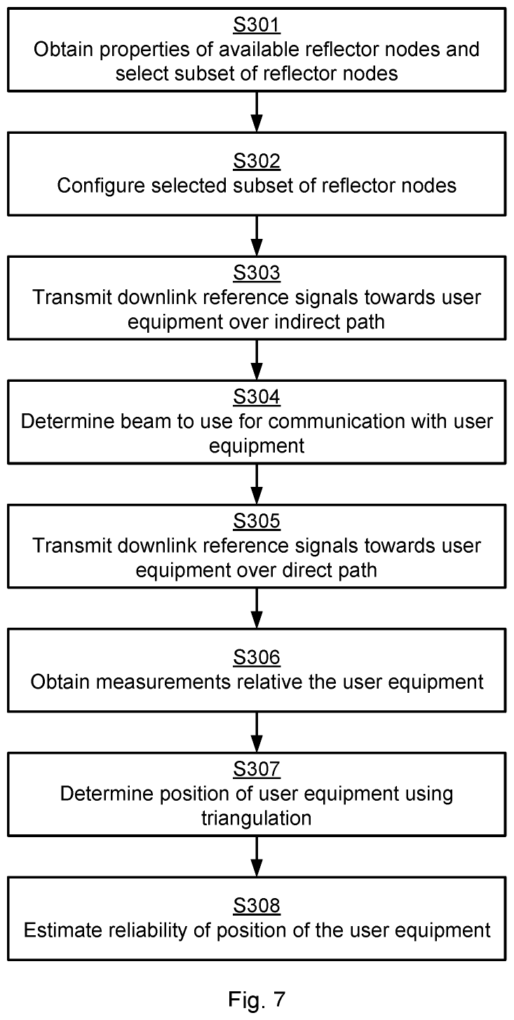

One particular embodiment for determining the position of the user equipment 300 based on downlink reference signals will now be disclosed in detail with reference to the flowchart of FIG. 7.
S301: The network node 200 obtains properties of all available reflector nodes 110 and selects a suitable subset of reflector nodes 110 based on the obtained properties.
S302: The network node 200 configures the selected subset of reflector nodes 110 to properly relay signals between the network node 200 and the user equipment 300.
S303: The network node 200 transmits at least one downlink reference signal in a beams towards each reflector node 110 in the selected subset of reflector nodes 110 for reflection of the at least one downlink reference signal towards the user equipment 300.
S304: The network node 200 determines which beam to use for communication with the user equipment 300 over the direct path 120.
S305: The network node 200 transmits at least one downlink reference signal towards the user equipment 300 in the beam determined in S304.
S306: The network node 200 obtains measurements relative the user equipment 300, where the measurements have been made by the user equipment 300 on the downlink reference signals transmitted in S303 and S305.
S307: The network node 200 determines the position of the user equipment 300 using triangulation based on the measurements.
S308: The network node 200 estimates reliability of the position of the user equipment 300 based on the obtained measurements.

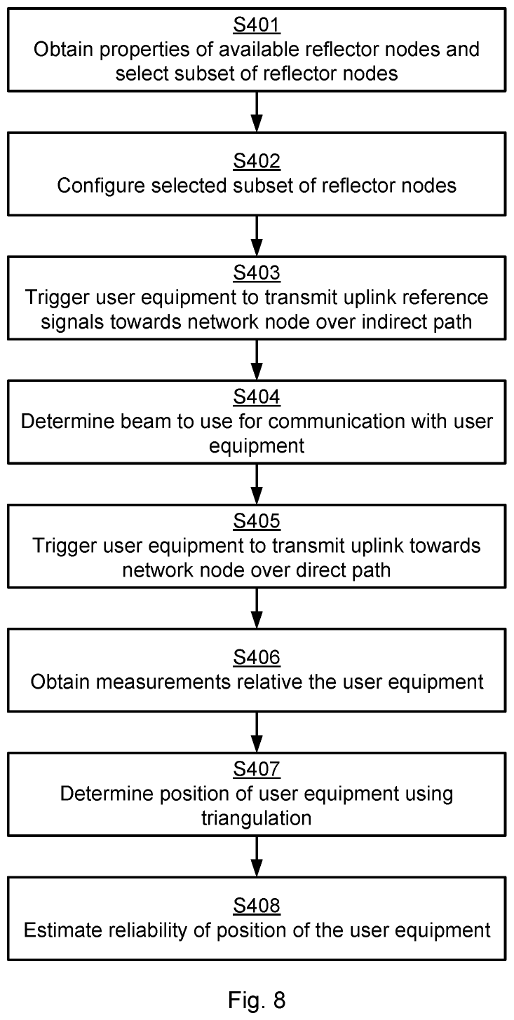

One particular embodiment for determining the position of the user equipment 300 based on uplink reference signals will now be disclosed in detail with reference to the flowchart of FIG. 8.
S401: The network node 200 obtains properties of all available reflector nodes 110 and selects a suitable subset of reflector nodes 110 based on the obtained properties.
S402: The network node 200 configures the selected subset of reflector nodes 110 to properly relay signals between the network node 200 and the user equipment 300.
S403: The network node 200 triggers the user equipment 300 to transmit at least one uplink reference signal in the direction, or directions, of the one or more reflector nodes 110 in the subset of reflector nodes 110.
S404: The network node 200 determines which beam to use for communication with the user equipment 300 over the direct path 120.
S405: The network node 200 triggers the user equipment 300 to transmit at least one uplink reference signal in the direction towards the network node 200.
S406: The network node 200 obtains measurements relative the user equipment 300, where the measurements are made by the network node 200 on uplink reference signals received from the user equipment 300 as triggered in S403 and S405.
S407: The network node 200 determines the position of the user equipment 300 using triangulation based on the obtained measurements.
S408: The network node 200 estimates reliability of the position of the user equipment 300 based on the obtained measurements.

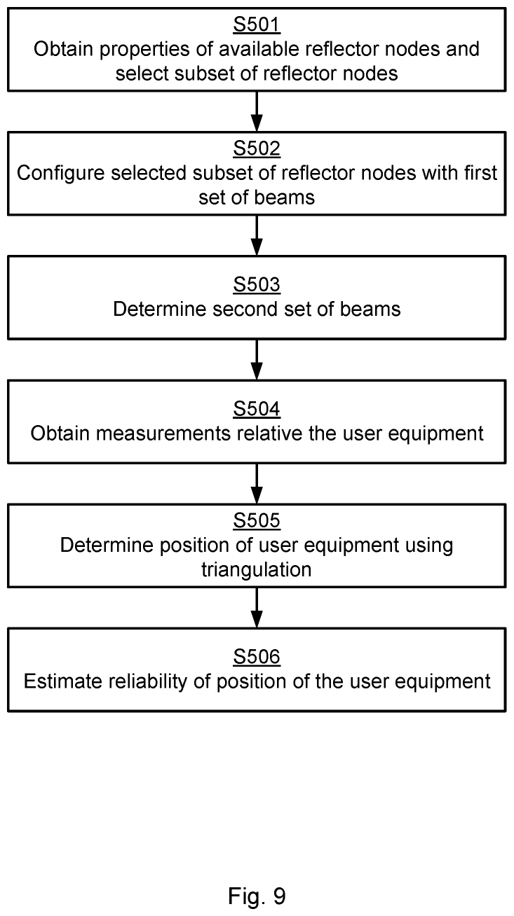

One particular embodiment for determining the position of the user equipment 300 based on directional information will now be disclosed in detail with reference to the flowchart of FIG. 9.
S501: The network node 200 obtains properties of all available reflector nodes 110 and selects a suitable subset of reflector nodes 110 based on the obtained properties.
S502: The network node 200 configures the selected subset of reflector nodes 110 to properly relay beamformed signals in a first set of beams B9:B16 between the network node 200 and the user equipment 300.
S503: The network node 200 determines a second set of beams B1:B8 to use for communication with the user equipment 300 over the direct path 120.
S504: The network node 200 obtains measurements relative the user equipment 300 by communicating signals with the user equipment 300. Signals between the network node 200 and the user equipment 300 are communicated over the indirect path 130a, 130b via the reflector node 110 whilst a beam sweep is made in the first set of beams B9:B16. Signals between the network node 200 and the user equipment 300 are further communicated the path 120 whilst a beam sweep is made in the second set of beams B1:B8. The measurements pertain to in which of the beams in the first set of beams B9:B16 and in which of the beams in the first set of beams B1:B8 the communicated signals were received with best quality. The signals could be either uplink signals or downlink signals, or a combination of both.
S505: The network node 200 determines the position of the user equipment 300 using triangulation based on the obtained measurements.
S506: The network node 200 estimates reliability of the position of the user equipment 300 based on the obtained measurements.

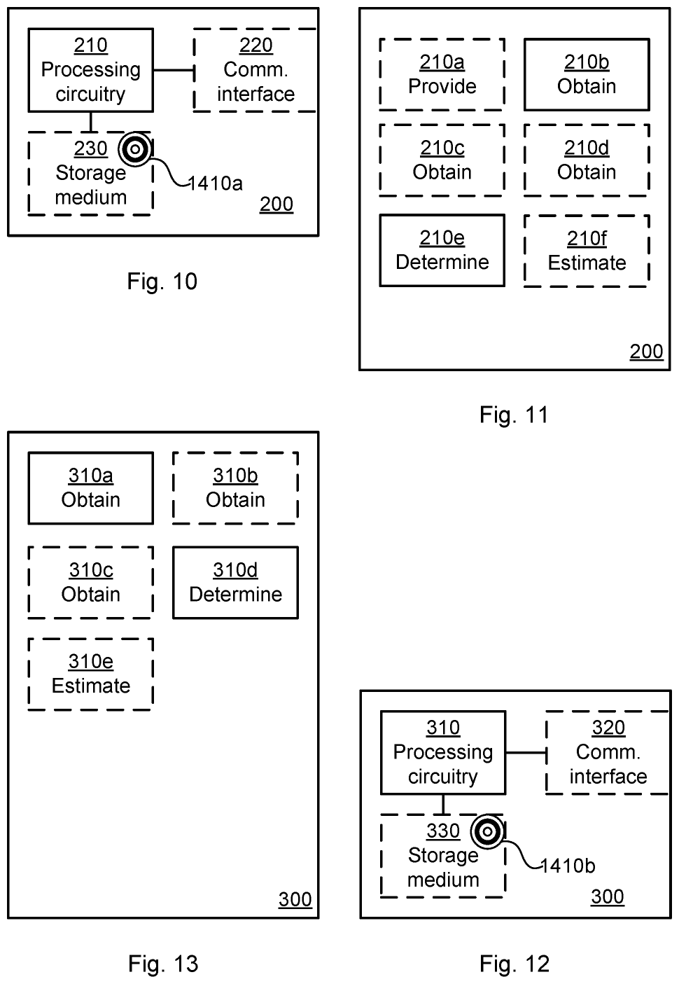

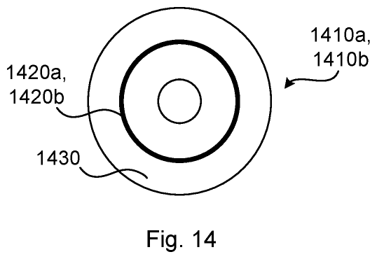

FIG. 10 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1410a (as in FIG. 14), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications interface 220 for communications with other entities, functions, nodes, and devices, such as the user equipment 300 and the controller module 112 of the reflector node 110. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 11 schematically illustrates, in terms of a number of functional modules, the components of a network node 200 according to an embodiment. The network node 200 of FIG. 11 comprises a number of functional modules; an obtain module 210b configured to perform step S104, and a determine module 2104 configured to perform step S110. The network node 200 of FIG. 11 may further comprise a number of optional functional modules, such as any of a provide module 210a configured to perform step S102, an obtain module 210c configured to perform step S106, an obtain module 210d configured to perform step S108, and an estimate module 210f configured to perform step S112. In general terms, each functional module 210a:210f may be implemented in hardware or in software. Preferably, one or more or all functional modules 210a:210f may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210f and to execute these instructions, thereby performing any steps of the network node 200 as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 10 the processing circuitry 210 may be distributed among a plurality of devices, or nodes. The same applies to the functional modules 210a:210f of FIG. 11 and the computer program 1420a of FIG. 14.

FIG. 12 schematically illustrates, in terms of a number of functional units, the components of a user equipment 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1410b (as in FIG. 14), e.g. in the form of a storage medium 330. The processing circuitry 310 may further be provided as at least one application specific integrated circuit (ASIC), or field programmable gate array (FPGA).

Particularly, the processing circuitry 310 is configured to cause the user equipment 300 to perform a set of operations, or steps, as disclosed above. For example, the storage medium 330 may store the set of operations, and the processing circuitry 310 may be configured to retrieve the set of operations from the storage medium 330 to cause the user equipment 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The user equipment 300 may further comprise a communications interface 320 for communications with other entities, functions, nodes, and devices, such as the network node 200. As such the communications interface 320 may comprise one or more transmitters and receivers, comprising analogue and digital components.

The processing circuitry 310 controls the general operation of the user equipment 300 e.g. by sending data and control signals to the communications interface 320 and the storage medium 330, by receiving data and reports from the communications interface 320, and by retrieving data and instructions from the storage medium 330. Other components, as well as the related functionality, of the user equipment 300 are omitted in order not to obscure the concepts presented herein.

FIG. 13 schematically illustrates, in terms of a number of functional modules, the components of a user equipment 300 according to an embodiment. The user equipment 300 of FIG. 13 comprises a number of functional modules; an obtain module 310a configured to perform step S202, and a determine module 310d configured to perform step S208. The user equipment 300 of FIG. 13 may further comprise a number of optional functional modules, such as any of an obtain module 310b configured to perform step S204, an obtain module 310c configured to perform step S206, and an estimate module 310e configured to perform step S210. In general terms, each functional module 310a:310e may be implemented in hardware or in software. Preferably, one or more or all functional modules 310a:310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310e and to execute these instructions, thereby performing any steps of the user equipment 300 as disclosed herein.

FIG. 14 shows one example of a computer program product 1410a, 1410b comprising computer readable means 1430. On this computer readable means 1430, a computer program 1420a can be stored, which computer program 1420a can cause the processing circuitry 210 and thereto operatively coupled entities and devices, such as the communications interface 220 and the storage medium 230, to execute methods according to embodiments described herein. The computer program 1420a and/or computer program product 1410a may thus provide means for performing any steps of the network node 200 as herein disclosed. On this computer readable means 1430, a computer program 1420b can be stored, which computer program 1420b can cause the processing circuitry 310 and thereto operatively coupled entities and devices, such as the communications interface 320 and the storage medium 330, to execute methods according to embodiments described herein. The computer program 1420b and/or computer program product 1410b may thus provide means for performing any steps of the user equipment 300 as herein disclosed.

In the example of FIG. 14, the computer program product 1410a, 1410b is illustrated as an optical disc, such as a CD (compact disc) or a DVD (digital versatile disc) or a Blu-Ray disc. The computer program product 1410a, 1410b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1420a, 1420b is here schematically shown as a track on the depicted optical disk, the computer program 1420a, 1420b can be stored in any way which is suitable for the computer program product 1410a, 1410b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for position determination of a user equipment, wherein the method is performed by a network node, wherein the network node serves the user equipment in a radio environment over at least one indirect path via a respective reflector node and over a direct path, wherein the location of the reflector node relative the location of the network node is known by the network node, and wherein the method comprises:
obtaining measurements relative the user equipment, wherein the measurements pertain to properties of the indirect path and the direct path, and wherein the measurements are based on signals communicated between the network node and the user equipment via the indirect path and via the direct path; and
determining the position of the user equipment using triangulation based on the measurements.

2. The method according to claim 1, wherein the signals are downlink reference signals sent by the network node towards the user equipment over the indirect path and the direct path, wherein the properties pertain to timing information, and wherein the measurements are made by the user equipment on the downlink reference signals and reported to the network node.

3. The method according to claim 1, wherein the signals are uplink reference signals sent by the user equipment and received by the network node over the indirect path and the direct path, wherein the properties pertain to timing information, and wherein the measurements are made by the network node on the uplink reference signals.

4. The method according to claim 2, wherein the position of the user equipment is determined based on propagation delays for the indirect path and the direct path as determined based on the timing information.

5. The method according to claim 2, wherein the timing information is defined by time-of-arrival values.

6. The method according to claim 1, wherein the signals are downlink signals sent in directional beams by the network node towards the user equipment over the indirect path and the direct path, wherein the properties pertain to directional information of the downlink signals, and wherein the measurements are made by the user equipment on the downlink signals and reported to the network node.

7. The method according to claim 1, wherein the signals are uplink signals sent by the user equipment and received by the network node and the reflector node in directional beams, wherein the properties pertain to directional information of the uplink signals, and wherein the measurements are made by the network node.

8. The method according to claim 6, wherein the position of the user equipment is determined based on the directional information for the indirect path and the direct path.

9. The method according to claim 6, wherein the directional information is defined by received signal power in the directional beams.

10. The method according to claim 6, wherein the directional information is defined by angle-of-arrival values.

11. The method according to claim 1, wherein the method further comprises:
obtaining further measurements relative the reflector node, said further measurements pertaining to properties of the indirect path between the network node and the reflector node, and wherein the position of the user equipment is determined also based on said further measurements.

12. The method according to claim 11, wherein the properties of the indirect path between the network node and the reflector node are at least one of propagation delay of the indirect path, and relative direction of the indirect path relative the network node.

13. The method according to claim 1, wherein, the reflector node has a processing delay and/or latency for reflecting the signals communicated between the network node and the user equipment via the reflector node, and wherein the measurements relative the user equipment are compensated for the processing delay and/or latency.

14. The method according to claim 1, wherein the method further comprises:
obtaining further measurements relative the user equipment from another network node, and wherein the position of the user equipment is determined also based on said further measurements.

15. The method according to claim 1, wherein the method further comprises:
estimating reliability of the position of the user equipment based on the obtained measurements.

16.-18. (canceled)

19. A method for position determination, wherein the method is performed by a user equipment, wherein the user equipment is served by a network node in a radio environment over at least one indirect path via a respective reflector node and over a direct path, wherein the location of the reflector node relative the location of the network node is known by the user equipment, and wherein the method comprises:
obtaining measurements relative the network node, wherein the measurements pertain to properties of the indirect path and the direct path, and wherein the measurements are based on signals communicated between the user equipment and the network node via the indirect path and via the direct path; and
determining the position of the user equipment using triangulation based on the measurements.

20.-34. (canceled)

35. A network node for position determination of a user equipment, wherein the network node is configured to serve the user equipment in a radio environment over at least one indirect path via a respective reflector node and over a direct path, wherein the location of the reflector node relative the location of the network node is known by the network node, the network node comprising processing circuitry, the processing circuitry being configured to cause the network node to:
obtain measurements relative the user equipment, wherein the measurements pertain to properties of the indirect path and the direct path, and wherein the measurements are based on signals communicated between the network node and the user equipment via the indirect path and via the direct path; and
determine the position of the user equipment using triangulation based on the measurements.

36.-37. (canceled)

38. A user equipment for position determination, wherein the user equipment is configured to be served by a network node in a radio environment over at least one indirect path via a respective reflector node and over a direct path, wherein the location of the reflector node relative the location of the network node is known by the user equipment, the user equipment comprising processing circuitry, the processing circuitry being configured to cause the user equipment to:
obtain measurements relative the network node, wherein the measurements pertain to properties of the indirect path and the direct path, and wherein the measurements are based on signals communicated between the user equipment and the network node via the indirect path and via the direct path; and
determine the position of the user equipment using triangulation based on the measurements.

39.-40. (canceled)

41. A computer program product for position determination of a user equipment, the computer program product comprising a non-transitory computer readable medium storing a computer program comprising code which, when run on processing circuitry of a network node, wherein the network node is configured to serve the user equipment in a radio environment over at least one indirect path via a respective reflector node and over a direct path, wherein the location of the reflector node relative the location of the network node is known by the network node, causes the network node to carry out the method according to claim 1.

42. A computer program product for position determination, the computer program product comprising a non-transitory computer readable medium storing a computer program comprising code which, when run on processing circuitry of a user equipment, wherein the user equipment is configured to be served by a network node in a radio environment over at least one indirect path via a respective reflector node and over a direct path, wherein the location of the reflector node relative the location of the network node is known by the user equipment, causes the user equipment to carry out the method according to claim 19.

43. (canceled)
